(19) United States
(12) Patent Application Publication
(10) Pub. No.: US 2004/0095735 A1
(43) Pub. Date: May 20, 2004

(54) Spring element fixture

(76) Inventor: William R. Ehrgott, Arroyo Grande, CA (US)

Correspondence Address: IRELL & MANELLA LLP, 840 NEWPORT CENTER DRIVE, SUITE 400, NEWPORT BEACH, CA, 92660, US

(21) Appl. No.: 10/295,262

(22) Filed: Nov. 14, 2002

(51) Int. Cl. H01R 9/00

(52) U.S. Cl. 361/772

(57) ABSTRACT

A tooling fixture that holds one or more electronic devices. The fixture has one or more cavities formed in the top surface of a substrate. Each cavity has a pair of spring fingers integrally formed in the substrate. The spring fingers bias the electronic device into a pair of locator edges of the cavity, insuring a repeatable accurate placement of the device. Forming the spring fingers within the substrate eliminates external parts and thus reduces the cost of producing the tool. Additionally, the integrally formed spring fingers allow minimal spacing between cavities and increase the number of devices that can be loaded onto a fixture.

### BACKGROUND OF THE INVENTION

1. Field of the Invention

The subject matter disclosed generally relates to a tooling fixture that supports electronic devices.

2. Background Information

Electro-optical devices such laser diodes are typically assembled into a package that is soldered to a printed circuit board. The devices are tested to insure compliance with certain design and manufacturing criteria. Devices such as laser diodes are typically tested by placing an electrode probe(s) in contact with the device.

It is desirable to automate the testing process of the devices. Automated processes are generally cheaper and less prone to human error than manual processes. Automated testing processes typically include a pick and place machine placing a plurality of devices onto a tooling fixture and then loading the fixture into a tester. The tester contains a number of probes that are pushed onto the devices.

It is desirable to accurately locate the devices within the tooling fixture in a repeatable manner. This insures that the test probes will be properly aligned with the devices. There have been developed tooling fixtures with external springs that bias the devices to a desired location. The external springs are bulky and limit the minimum spacing between devices within the fixture. The minimum spacing defines the number of devices that can be tested on a given fixture. External springs also increase the complexity and resultant cost of the fixture.

### BRIEF SUMMARY OF THE INVENTION

A tooling fixture which has a spring finger formed into a top surface of a substrate. The tooling fixture holds an electronic device within a cavity of the substrate.

### BRIEF DESCRIPTION OF THE DRAWINGS

FIG. 1 is a perspective view of a tooling fixture;

FIG. 2 is an enlarged perspective view of a device cavity of the fixture;

FIG. 3 is a top view of the device cavity showing a pair of spring fingers moved to an open position;

FIG. 4 is a top view of the device cavity with a device placed into the cavity;

FIG. 5 is a top view of the device cavity with the spring fingers in a loaded position;

FIG. 6 is a cross-sectional view showing a cam actuator;

FIG. 7 is a cross-sectional view showing an elastomeric actuator.

### DETAILED DESCRIPTION

Disclosed is a tooling fixture that holds one or more electronic devices. The fixture has one or more cavities formed in the top surface of a substrate. Each cavity has a pair of spring fingers integrally formed into the substrate. The spring fingers bias the electronic device into a pair of locator edges of the cavity, insuring a repeatable accurate placement of the device. Forming the spring fingers within the substrate eliminates external parts and thus reduces the cost of producing the tool. Additionally, the integrally formed spring fingers allow minimal spacing between cavities and increase the number of devices that can be loaded onto a fixture.

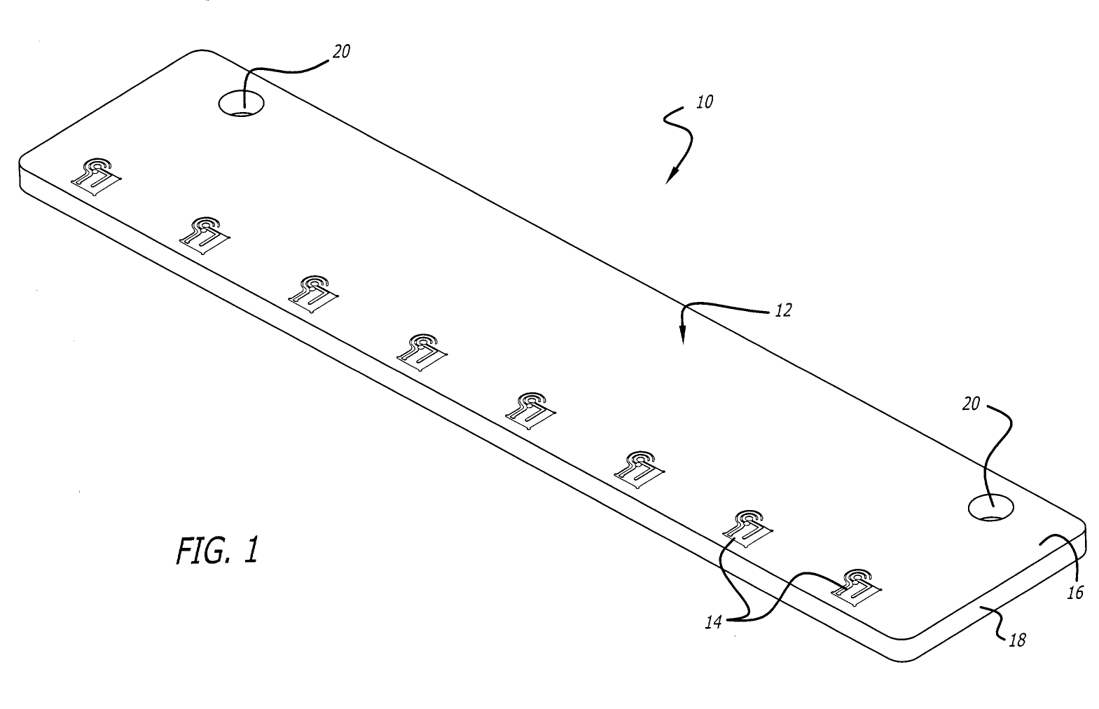

Referring to the drawings more particularly by reference numbers, FIG. 1 shows a tooling fixture 10. The tooling fixture 10 includes a substrate 12 that has a plurality of device cavities 14. The substrate 12 may include a locator plate 16 that is attached to a base plate 18. The plates 16 and 18 are preferably constructed from a metal such as aluminum to provide a thermal heat sink. The substrate 12 may have a pair of alignment holes 20 that allow the fixture 10 to be accurately loaded into a machine such as an electrical tester (not shown).

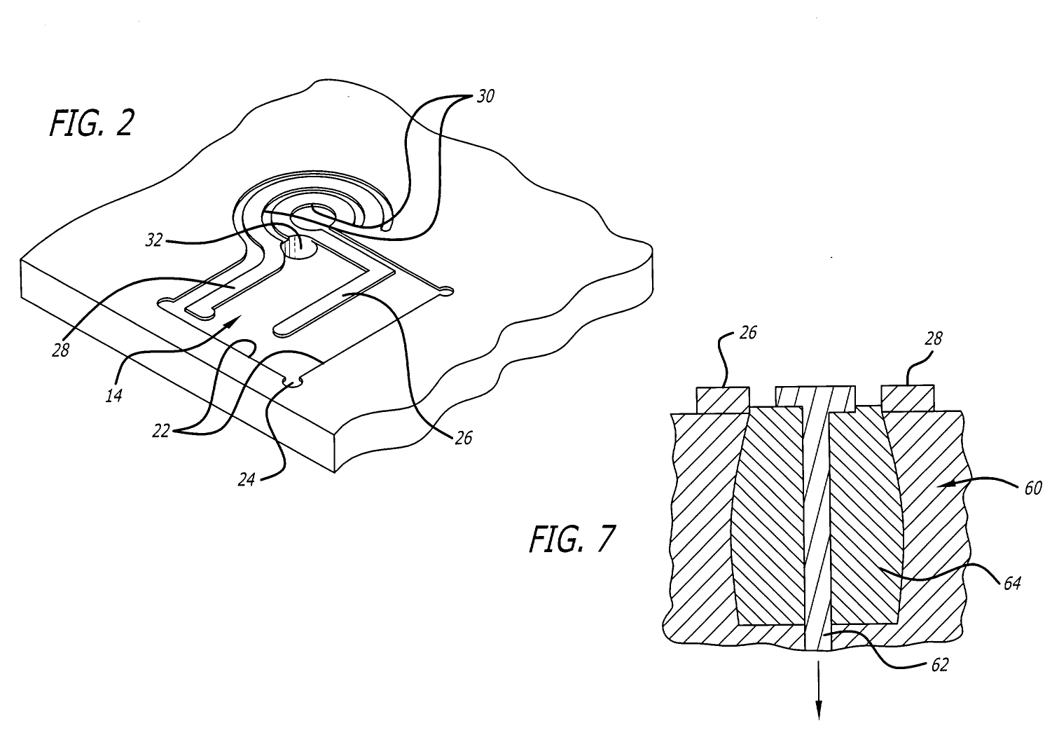

FIG. 2 shows a device cavity 14. Each cavity 14 contains a pair of locator edges 22. The locator edges 22 accurately locate the electronic devices (not shown) within the cavity 14. The locator edges 22 may include a relief groove 24 that allows a rectangular shape device to be pushed flush against the edges 22.

Each cavity 14 may contain a first spring finger 26 and a second spring finger 28. The spring fingers 26 and 28 can push an electronic device into the locator edges 22 and thus repeatably locate the device within the cavity 14. The spring fingers 26 and 28 may each include a coil section 30 that allows deflection of the fingers 26 and 28 while exerting a spring force onto the device. The fingers 26 and 28 are formed into the locator plate 16 of the substrate 12. The cavity 14 and fingers 26 and 28, may be machined, or etched from the locator plate 16. The locator 16 is then attached to the base plate 18. Each cavity 14 may also have a clearance hole 32.

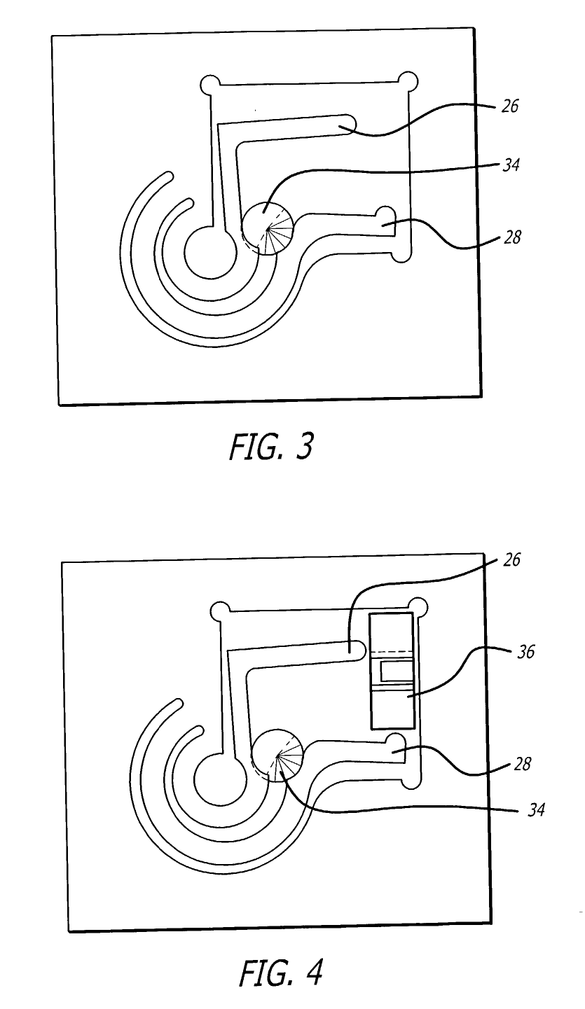

As shown in FIG. 3 a tapered actuator pin 34 may be inserted into the clearance hole 32 to move the spring fingers 26 and 30 to an open position. As shown in FIG. 4 an electronic device 36 is then placed into the cavity 14. Movement of the spring fingers 26 and 28 to the open position provides clearance for the device 36. To prevent bending of the finger edges the fixture 10 may have a limiter plate (not shown) to limit the upward deflection of the fingers 26 and 28 when the pin 34 is moved into the open position.

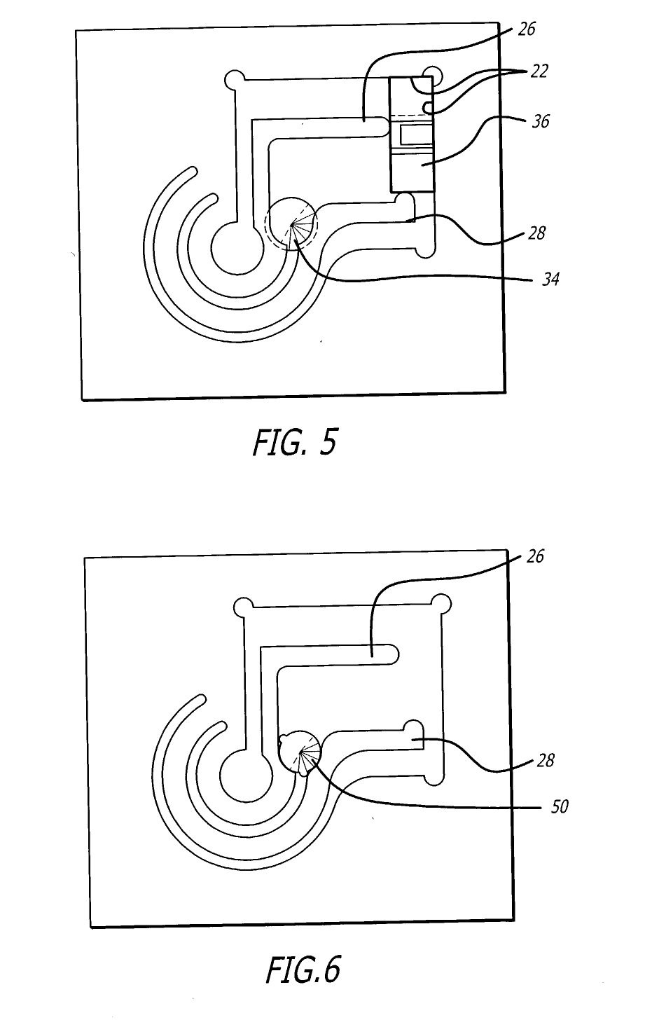

As shown in FIG. 5 the pin 34 is pulled down into the clearance hole 32 and the spring fingers 26 and 28 move back to exert spring forces onto the device 36. The spring forces push the device 36 into the locator edges 22 of the cavity 14. Pushing the electronic device 36 into the locator edges 22 with the spring fingers 26 and 28 creates a repeatable method for accurately locating the device 36 in the fixture 10.

The fixture 10 can then be loaded into a tester. The tester may have one or more electrode probes that are pushed onto the device 36. The electronic device 36 can be removed by pulling the device 36 out of the cavity 14 with or without moving the fingers 26 and 28 to the open position.

FIG. 6 shows an alternate embodiment of the tooling fixture that has a cam 50 that can be rotated to move the fingers 26 and 28 between the open and closed position.

FIG. 7 shows an alternate embodiment of the tooling fixture that has an elastomeric actuator 60 that can move the fingers 26 and 28 between the open closed positions. The actuator 60 may include a pin 62 that extends through an elastomeric bushing 64. Pulling the pin 62 expands the bushing 64 and moves the fingers 26 and 28 to the open position. The use of an elastomer eliminates upward bending of the finger edges and formation of particles during the actuation process.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A tooling fixture for supporting an electronic device, comprising:
a substrate which has a cavity and a first spring finger formed in said substrate.

2. The fixture of claim 1, wherein said cavity has a pair of locator edges.

3. The fixture of claim 1, further comprising a second spring finger formed in said substrate.

4. The fixture of claim 1, further comprising an actuator pin coupled to said first spring finger.

5. The fixture of claim 1, further comprising a cam coupled to said first spring finger.

6. The fixture of claim 1, further comprising an elastomeric actuator coupled to said first spring finger.

7. The fixture of claim 2, wherein said locator edges have a relief groove.

8. The fixture of claim 3, wherein said first and second spring fingers each have a coil section.

9. The fixture of claim 1, wherein said substrate is constructed from a metal.

10. A tooling fixture for supporting an electronic device, comprising:
a substrate which has a cavity that has a pair of locator edges; and,
spring means for biasing the electronic device into said locator edges.

11. The fixture of claim 10, wherein said spring means includes a first spring finger and a second spring finger formed in said substrate.

12. The fixture of claim 10, further comprising actuator means for actuating said spring means.

13. The fixture of claim 12, wherein said actuator means includes a pin that extends through a clearance hole in said substrate.

14. The fixture of claim 12, wherein said actuator means includes a cam.

15. The fixture of claim 12, wherein said actuator means includes an elastomeric actuator.

16. The fixture of claim 10, wherein said locator edges have a relief groove.

17. The fixture of claim 11, wherein said first and second spring fingers each have a coil section.

18. The fixture of claim 10, wherein said substrate is constructed from a metal.

19. A method for loading an electronic device into a tooling fixture, comprising:
moving a spring finger formed within a substrate;
placing an electronic device into a cavity of the substrate; and,
moving the spring finger so that the spring finger pushes the electronic device into a locator edge of the cavity.

20. The method of claim 19, wherein the spring finger is moved with a pin.

21. The method of claim 19, wherein the spring finger is moved with a cam.

22. The method of claim 19, wherein the spring finger is moved with an elastomer.

23. The method of claim 19, further comprising probing the electronic device.

24. The method of claim 19, wherein the spring finger is etched from the substrate.

25. The method of claim 19, wherein the spring finger is machined from the substrate.
